(19) United States
(12) Patent Application Publication
(10) Pub. No.: US 2014/0377650 A1
(43) Pub. Date: Dec. 25, 2014

(54) ASSEMBLY CONSISTING OF A CURRENT COLLECTOR AND A SILICON ELECTRODE

(71) Applicant: COMMISSARIAT A L'ENERGIE ATOMIQUE ET AUX ENERGIES ALTERNATIVES, Paris (FR)

(72) Inventors: Pascal Tiquet, Grenoble (FR); Sebastien Donet, Meaudre (FR); Lionel Filhol, Saint Sauveur (FR)

(73) Assignee: COMMISSARIAT A L'ENERGIE ATOMIQUE ET AUX ENERGIES ALTERNATIVES, Paris (FR)

(21) Appl. No.: 14/375,545

(22) PCT Filed: Feb. 5, 2013
(86) PCT No.: PCT/EP2013/052241

§ 371 Date: Jul. 30, 2014

(30) Foreign Application Priority Data
Feb. 7, 2012 (FR) 1251129

(51) Int. Cl. H01M 4/62; H01M 10/0525; H01M 4/587; H01M 4/36; H01M 4/38

(52) U.S. Cl. CPC H01M 4/622; H01M 4/625; H01M 4/366; H01M 4/386; H01M 4/587; H01M 10/0525
USPC 429/217

(57) ABSTRACT

The invention relates to an assembly comprising a current collector and a silicon electrode, wherein the current collector and the electrode are connected together via at least one of the surfaces thereof by an elastic polymer layer. The invention can be used in the field of lithium batteries.

### TECHNICAL FIELD

The present invention relates to a novel current collector-electrode assembly based on silicon intended to be used in the conception of lithium batteries.

The general field of the invention may thus be defined as being that of lithium batteries.

Lithium batteries are increasingly used as autonomous energy sources, in particular in portable electronic equipment (such as mobile telephones, laptop computers, tooling), where they are progressively replacing nickel-cadmium (NiCd) and nickel-metal hydride (NiMH) batteries. They are also widely used to provide the energy supply required for new micro-applications, such as chip cards, sensors or other electromechanical systems.

Lithium batteries of commercially available lithium-ion type normally have a nominal voltage of 3.7 volts, an extremely low self-discharge and currently enable the storage of around 160-180 Wh/kg and 420-500 Wh/kg in an extended range of operating temperatures (−20° C. to +65° C.).

These lithium batteries operate on the principle of insertion-deinsertion (or intercalation-deintercalation) of lithium according to the following principle.

During the discharge of the battery, the lithium deinserted from the negative electrode in the ionic form Li⁺ migrates through the ion conductive electrolyte and inserts itself in the crystal lattice of the active material of the positive electrode. The passage of each Li⁺ ion in the internal circuit of the battery is exactly compensated by the passage of an electron in the external circuit, thereby generating an electric current. The mass energy density released by these reactions is at one and the same time proportional to the potential difference between the two electrodes and to the quantity of lithium that will be inserted in the active material of the positive electrode.

During charging of the battery, the reactions taking place within the battery are reverse discharge reactions, namely:
the negative electrode is going to insert lithium in the crystal lattice of the material constituting it;
the positive electrode is going to release lithium.

By virtue of this operating principle, lithium batteries require two different insertion compounds at the negative electrode and at the positive electrode.

The positive electrode is generally based on lithiated oxide of transition metal:
of the lamellar oxide type of formula LiMO₂, where M designates Co, Ni, Mn, Al and mixtures thereof, such as LiCoO₂, LiNiO₂, Li(Ni,Co,Mn,Al)O₂; or
of the oxide type of spinel structure, such as LiMn₂O₄.

The negative electrode may be based on a carbon material, and in particular based on graphite.

Graphite has a theoretical specific capacity of the order of 372 mAh/g (corresponding to the formation of the alloy LiC₆) and a practical specific capacity of the order of 320 mAh/g. Nevertheless, graphite exhibits high irreversibility during the first charge, a continuous loss of capacity in cycling and a totally unacceptable kinetic limitation in the case of high charge/discharge rate (for example, for a C/2 charge rate).

With a view to improving the insertion properties of lithium in the negative electrode, researchers have focused their efforts on the search for new electrode materials.

Thus, they have discovered that materials or elements capable of forming an alloy with lithium are able to constitute excellent alternatives to the use of graphite.

It is in this way that it has been demonstrated that the insertion of silicon in a negative electrode made it possible to significantly increase the specific capacity of the negative electrode linked to the insertion of lithium therein, which is 320 mAh/g for a graphite electrode and 3578 mAh/g for a silicon electrode (corresponding to the formation of the alloy Li₁₅Si₄ during the insertion at ambient temperature of lithium in silicon). Thus, through simple predictions, it is possible to envisage a gain of around 40 and 35%, respectively in volume energy and in mass energy, if the graphite is replaced by silicon in a conventional battery of the “lithium-ion” sector. Furthermore, the operating potential window of the lithium-silicon alloy of formula Li₁₅Si₄ (0.4-0.05 V/—Li—Li⁺) higher than that of graphite, makes it possible to avoid the formation of a deposition of metal lithium and the associated risks, while leaving the possibility of achieving faster charges. In addition, it is established that the reaction of formation of the lithium-silicon alloy, leading to a very high capacity (of the order of 3578 mAh/g), is reversible.

Nevertheless, the use of silicon in a negative electrode of a lithium battery poses a certain number of problems.

In particular, during the reaction of formation of the silicon-lithium alloy (corresponding to the insertion of lithium in the negative electrode in the charge process), the volume expansion between the delithiated phase and the lithiated phase may reach values ranging from 240 to 400%. This strong expansion, followed by a contraction of same amplitude (corresponding to the deinsertion of lithium in the negative electrode during the discharge process) may cause rapidly irreversible mechanical damage of the electrode.

What is more, due to the swelling of the silicon generated by the insertion of lithium, an important loading of the current collector-electrode interface ensues, inevitably leading to rupture of adherence between said collector and said electrode and even fissures at the level of the collector, which contributes to reducing the collecting surface of the battery.

The authors of the present invention thus set themselves the objective of proposing a current collector-electrode assembly making it possible to overcome the aforementioned drawbacks.

### DESCRIPTION OF THE INVENTION

Thus, the invention relates to an assembly comprising a current collector and an electrode comprising silicon in its elementary form, characterized in that said current collector and said electrode are connected together by at least one of the surface thereof by an elastic polymer layer.

Due to the presence of an elastic polymer layer between the silicon electrode and the current collector, the deformations induced by the swelling of the silicon during phenomena of insertion of lithium in a lithium battery are absorbed by said polymeric layer, which makes it possible to preserve the collector-electrode interface from any phenomenon of mechanical degradation.

It is pointed out that elastic polymer layer is taken to mean a layer comprising one or more polymers able, after having been deformed, to recover its initial shape and its volume.

This elastic polymer layer may comprise, thus, one or more polymers selected from thermoplastic polymers, thermosetting polymers, elastomers, from the moment that they are elastic, and mixtures thereof.

As examples of thermoplastic polymers may be cited polymers derived from the polymerisation of aliphatic or cycloaliphatic vinylic monomers, such as polyolefins (among which polyethylenes or instead polypropylenes are particularly suited for this invention), polymers derived from the polymerisation of aromatic vinylic monomers, such as polystyrenes, polymers derived from the polymerisation of acrylic and/or (meth)acrylate monomers, polyamides, polyetherketones, polyimides.

As examples of thermosetting polymers may be cited thermosetting resins (such as epoxy resins, polyester resins) optionally in mixture with polyurethanes or with polyol polyethers or vice versa.

As examples of elastomeric polymers may be cited natural rubbers (derived from latexes collected in rubber tree plantations), synthetic rubbers, styrene-butadiene copolymers (also known by the abbreviation “SBR”), ethylene-propylene copolymers (also known by the abbreviation “EPM”), silicones. These polymers may be vulcanised by oxygen, sulphur or any other chemical element able to enable said vulcanisation.

As mentioned above, the polymeric layer may be made of a mixture of thermoplastic polymer(s), thermosetting polymer(s) and/or elastomeric polymer(s).

Thus, for example, the polymeric layer may be made of:
a mixture of thermosetting resins (such as epoxy resins, polyester resins) with polyurethanes or with polyol polyethers;
a mixture of polymer(s) derived from the polymerisation of aromatic, aliphatic and/or cycloaliphatic vinylic monomers with a polyurethane or a styrene-butadiene elastomer.

Preferably, the elastic polymer layer is formed of one or more elastomeric polymers as mentioned above.

This elastic polymer layer may also assure an adhesive function, so as to confer cohesion to the assembly constituted of the current collector and the electrode.

This elastic polymer layer may also be an electricity insulating layer, thereby electrically insulating the current collector from the electrode.

Thus, the current collector-electrode assembly may further comprise means of electrical connection between said current collector and said electrode, said means being able to take the form of electricity conducting elements connecting the current collector to said electrode and passing through said elastic polymer layer. Said means may form an integral part of the current collector.

According to the invention, the current collector may be in the form of an electricity conducting substrate, for example, a metal substrate (said metal substrate being able to be in the form of a metal strip).

As examples, it may be a metal substrate constituted of one or more metal elements selected from copper, aluminium, nickel and mixtures thereof.

According to a particular embodiment of the invention, the current collector may be in the form of an electricity conducting substrate coated with a bundle of carbon nanotubes, said nanotubes being able to be arranged perpendicularly with respect to the surface of said substrate and parallel to each other and advantageously passing through the elastic polymer layer, so as to be in contact with the electrode.

This substrate may be made of an electricity conducting material capable of serving as base for the growth of the carbon nanotubes.

The electricity conducting substrate may be:
a substrate based on a metal element, for example a substrate made of aluminium or a substrate consisting of a film made of metallised plastic material;
a substrate based on a non-metal element, such as a doped silicon substrate;
a substrate made of a carbon material, such as graphite, graphene, carbon nanotubes.

Thus, said bundle of carbon nanotubes enables the electrical connection between the substrate constituting the current collector and the electrode.

The substrate may have a thickness below 100 μm, for example below 50 μm, (for example comprised between 5 and 30 μm), for example equal to 10 μm.

Moreover, the bundle of carbon nanotubes may assure, at one and the same time, the function of injection and extraction of the electric current in the volume of the electrode and the function of assuring, whatever the level of deformation, contact with said electrode (by virtue of the flexibility inherent in carbon nanotubes).

What is more, the carbon nanotubes assure an important security role, because they are only destroyed at high intensities, for example, for intensity values exceeding 500 nA.

The carbon nanotubes may be single-walled or multi-walled nanotubes and may have a distribution density of 10⁸ nanotubes/cm² and have a length ranging from 10 μm to 100 μm, for example 50 μm.

As mentioned above, the electrode comprises silicon in its elementary form (in other words silicon at its 0 degree of oxidation not combined with other elements).

Apart from the presence of silicon, the electrode may comprise a carbon material, such as carbon black, activated carbon (for example, marketed under the denomination “Super P”), carbon nanotubes, whether they are single, double or multi-walled, carbon fibres, graphene, fullerene and mixtures thereof.

From a structural viewpoint, the silicon and the carbon material may organise themselves in the form of a “core-shell” type structure, the core being constituted of the carbon material and the shell being constituted of silicon, or vice versa.

As examples, the electrode may comprise “core-shell” type structures, for which:
the core is constituted of carbon nanotubes and the shell is constituted of silicon; or
the core is constituted of silicon and the shell is constituted of graphene or fullerene.

As examples, a particular assembly according to the invention is an assembly comprising:
as current collector, a substrate made of aluminium coated on one of the surfaces thereof with a bundle of carbon nanotubes;
as electrode, an electrode made of composite material comprising silicon in its elementary form and a carbon material (for example, a carbon material as defined above),

the bundle of carbon nanotubes passing through the elastic polymer layer so as to be in contact with said electrode.

Moreover, the elastic polymer layer may be made of a styrene-butadiene copolymer.

The assembly according to the invention may be formed by simple techniques within the scope of those skilled in the art.

Thus, the assembly according to the invention may be formed by pressing the elastic polymer layer sandwiched between the current collector and the electrode.

The assembly according to the invention may also be formed by the following succession of steps:
a step of deposition by spraying of an elastic polymer layer on one surface of the electrode;
a step of pressing the current collector onto the elastic polymer layer thereby obtained.

More particularly, the step of spraying may be carried out by electrostatic spraying, corona discharge spraying or flame spraying.

When the current collector consists of a metal substrate coated with a bundle of carbon nanotubes, this may be prepared prior to the aforementioned pressing step, this preparation being able to consist in making the carbon nanotubes grow on said substrate.

These carbon nanotubes may be prepared according to different methods, among which may be cited:
high temperature methods using an energy source selected from laser, electric arc and using a carbon target;
medium temperature methods, based on the decomposition of a hydrocarbon gas on a metal catalyst.

For high temperature methods, the energy source (electric arc or laser ablation) serves to vaporise an element mainly constituted of carbon, such as graphite, commonly known as target, in predetermined places of the substrate, such that at the end of said method a bundle of carbon nanotubes is formed. The high concentration of energy generated by the source makes it possible to raise the temperature locally, near to the target, above 3000° C. From the moment where the target vaporises, a plasma is created containing carbon particles of atomic dimensions. These particles react together within the plasma to form carbon nanotubes.

For medium temperature methods based on the decomposition of a hydrocarbon gas on a metal catalyst, more particularly may be cited conventional CVD type methods (CVD signifying Chemical Vapour Deposition) which takes place, preferably, in a fluidised bed. The hydrocarbon gas may be acetylene, xylene, methane, ethylene, propylene. In particular conditions of pressure and temperature, the gas entering into contact with the metal catalyst particles decomposes and the particles of carbon react together to form carbon nanotubes, from the location of the metal catalyst particles. The metal catalyst particles may be based on Ni, Co, Fe and are deposited on the metal substrate, optionally covered with a barrier layer (for example, titanium nitride, silica) to avoid diffusion of the catalyst in the substrate. These metal catalyst particles are laid out, preferably, according to a predetermined arrangement, as a function of the envisaged quantity of carbon nanotubes and the desired spacing between the carbon nanotubes. To control the deposition of the metal catalyst particles on the substrate, it may be envisaged, prior to the deposition of said particles, to mask physically or chemically, according to the principle of photolithography, the parts of the substrate that it is desired free of carbon nanotubes at the end of the method.

Generally speaking, the reaction temperature does not exceed 900° C.

Once the nanotubes have been synthesized, it may be envisaged to carry out a step of elimination of the catalyst(s), in order that it does not interact with the lithium when said material is used in a negative electrode for lithium battery. The elimination of the metal catalyst particles may take place by chemical attack with nitric acid followed, in certain cases, by a high temperature heat treatment (for example, 700° C. to 2000° C.), in order to eliminate the remaining catalyst particles, as well as any surface impurities.

Medium temperature methods based on the use of catalyst particles are particularly advantageous for the implementation of the invention, in so far as they enable selectivity in the arrangement of the carbon nanotubes, by playing on the arrangement of the metal catalyst particles on the substrate, the growth of the nanotubes taking place uniquely from the location of said particles.

With this type of current collector, the pressing step will be accompanied by passing the carbon nanotubes through the elastic polymer layer, so that they come into contact with the electrode.

The electrode, for its part, when it does not pre-exist, may be prepared prior to the pressing step.

As examples, when it is composed of a composite material comprising silicon and carbon nanotubes, it may be prepared by the following succession of steps:
a step of preparing a mixture comprising silicon and carbon nanotubes, optionally in the presence of a binder (for example, an alginate);
a step of consolidation of this mixture in the form of an electrode, for example, by heat treatment.

Before the pressing step, the elastic polymer layer may be placed in contact beforehand with the electrode, the assembly resulting from this elastic polymer layer with the electrode then being pressed with the current collector by a surface of the elastic polymer layer.

The current collector-electrode assembly according to the invention may be placed in lithium batteries, where the electrode of said assembly will constitute the negative electrode.

This assembly used to constitute negative electrodes for a lithium battery has the advantage in particular of being highly resistant, after a consequent number of cyclings, due to the fact that deformation of the electrode layer is absorbed by the elastic polymer layer, which thus no longer disbonds from the current collector.

The invention also relates to a lithium battery comprising at least one assembly as defined above. More particularly, the lithium battery belongs to the “lithium-ion” sector, in other words that the lithium is never present in the battery in metal form but goes back and forward between the two lithium insertion compounds contained in the positive and negative electrodes at each charge and discharge of the battery.

The lithium battery of the invention conventionally comprises at least one electrochemical cell comprising:
an assembly as defined above, for which the electrode constitutes the negative electrode of the battery;
a positive electrode; and
a separator arranged between said assembly via the electrode layer and said positive electrode, which separator comprises a lithium ion conducting electrolyte.

The positive electrode may be made of lithium metal or may comprise a material selected from lithiated phosphates of transition metals, lithiated oxides of transition metals and mixtures thereof.

As examples of lithiated phosphates that may be used, LiFeₓ₁Mn₁₋ₓ₁PO₄ with 0≦x₁≦1 may be cited.

These materials have an olivine type structure.

As examples of lithiated oxides of transition metals, lamellar oxides Li(Co, Ni, Mn, Al)O₂ and oxides of spinel structure of Li₁₊ₓMn₂O₄ type with 0≦x≦0.1 may be cited.

The separator may be in the form of a porous element containing a liquid containing a lithium ion conducting liquid electrolyte.

The porous element may be in the form of a polymer, for example made of polyethylene or polypropylene or an association of the two.

The liquid electrolyte comprises for example an aprotic liquid solvent, for example, of carbonate type, such as ethylene carbonate, propylene carbonate, dimethyl carbonate or diethyl carbonate, a solvent or mixture of solvents of ether type, such as dimethoxyethane, dioxolane, dioxane, in which is dissolved a lithium salt.

As examples, the lithium salt may be selected from the group constituted of LiPF₆, LiClO₄, LiBF₄, LiAsF₆, LiCF₃SO₃, LiN(CF₃SO₂)₃, LiN(C₂F₅SO₂).

The invention will now be described with reference to the particular embodiment given by way of illustration and non-limiting.

### BRIEF DESCRIPTION OF THE DRAWINGS

FIG. 1 represents a sectional view of a current collector-electrode assembly according to the particular embodiment described below.

FIG. 2 represents a graph illustrating the evolution of the capacity C (in mA.h/g) as a function of the number of cycles N, curve a corresponding to the test carried out with the assembly according to the invention and curve b corresponding to the test carried out with an assembly not according to the invention.

### DETAILED DESCRIPTION OF A PARTICULAR EMBODIMENT

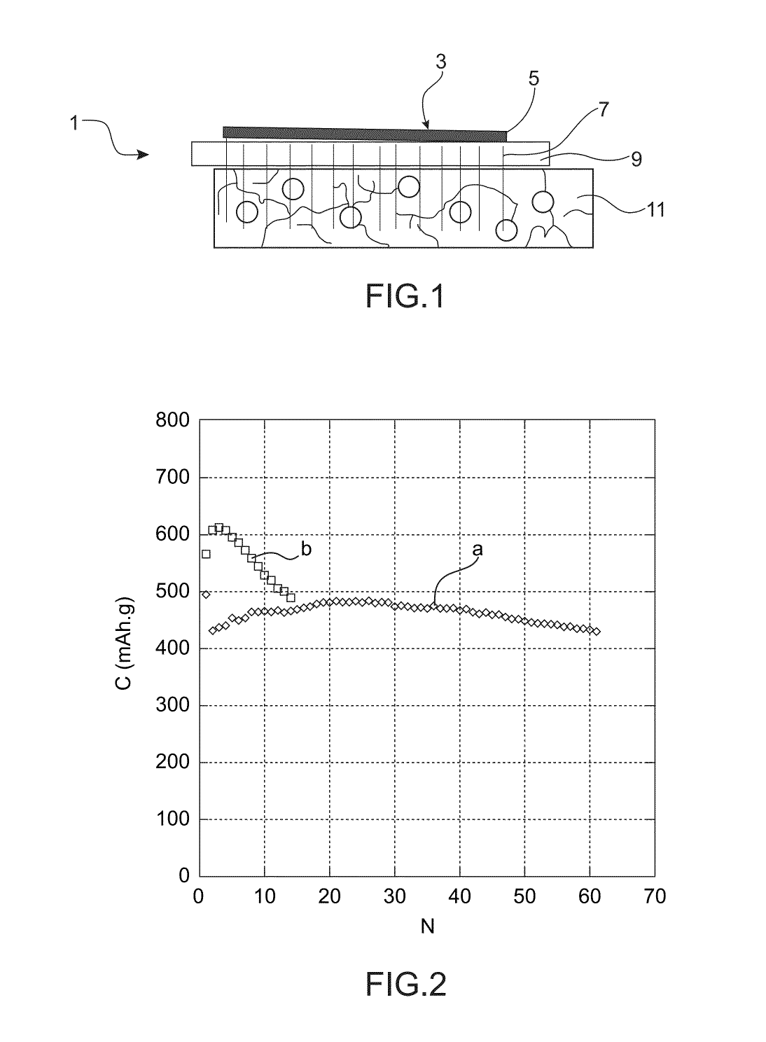

The example described below illustrates the preparation of a current collector-electrode assembly represented in appended FIG. 1, said assembly being composed of a stack comprising a current collector substrate made of aluminium coated, on one of the surfaces thereof, with a carpet of carbon nanotubes, the substrate being in contact via its coated surface with the carpet, with a first surface of an elastic polymer layer, the latter being in contact, via a second surface opposite said first face, with an electrode layer.

1) Formation of the Electrode

Firstly, an ink is prepared by mixing 0.3 g of alginate, 1.5 g of a silicon powder (having an average particle size of 310 nm), 0.1125 g of short carbon fibres (<10 μm) and 0.1125 g of carbon black of super P type.

The alginate has the function:

a) of binding the active materials with the electron conductor;

b) of making the electrode adhere to the carbon nanotubes and to the elastic polymer layer.

The silicon powder used is passivated with a layer of oxide not extending beyond 10 nm thickness, the active surface not having to exceed 30 m²/g.

Secondly, the ink thereby prepared is deposited, by spread coating, on a latex-alumina composite support to form a layer of thickness 150 μm, said layer then being dried then compressed at 1000 kg/cm².

The latex-alumina composite support meets the following specificities:
a ratio by volume of 20% latex and 80% alumina;
a surface energy comprised between 20 and 60 ml/m²;
the following pore distribution: [0-200 nm]=[10% and 20%]; [200 nm-600 nm]=[30% and 75%] and [>600 nm]=[5% and 60%).

Finally, thirdly, the resulting assembly is subjected to a step of carbonisation at 700° C. for 1 hour in the presence of a slightly reducing argon-H₂ gaseous mixture (3% by volume of H₂), whereby an electrode layer remains. This carbonisation step enables the electrode to no longer contain organic compounds, which are replaced by amorphous carbon resulting from said carbonisation. The amorphous carbon derived from the carbonisation plays the role of cement for the electrode structure and thus guarantees its cohesion. During the carbonisation, the latex is also destroyed by a pyrolytic mechanism. The carbonisation step is followed by a step of sintering at 1400° C. in air for 1 hour, so as to consolidate the grains of alumina remaining from the carbonisation treatment.

2) Formation of the Stack

On the electrode layer obtained previously (of a thickness of 2 μm), a polymeric layer made of a flexible, insulating and adherent styrene-butadiene latex is deposited by sputtering.

On this polymeric layer is applied, by pressing, a current collector comprising an aluminium sheet of a thickness of 10 μm coated with a bundle of single-walled and multi-walled carbon nanotubes of a length of 10 μm, whereby the carbon nanotubes pass through the elastic polymer layer and come into contact with the electrode layer.

An assembly remains comprising a stack of layers such as represented in appended FIG. 1, for which the references reported in this figure represent respectively the following elements:
for the reference 1, the complete assembly obtained at the end of this example;
for the reference 3, the current collector;
for the reference 5, the aluminium substrate belonging to the current collector;
for the reference 7, the bundle of carbon nanotubes starting from the substrate 5 and passing through the polymeric layer so as to arrive in contact with the electrode layer;
for the reference 9, the elastic polymer layer; and
for the reference 11, the electrode layer as such.

The assembly obtained according to this example shown in a button cell type structure has been subjected to a cycling test at a capacity C/20 (it being carried out at C/20 for 5 hours then C/10 up to 4.2 V and cycling at 20° C. at C/20 at 100% of the capacity).

A button cell comprising an assembly not according to the invention has been subjected to this same cycling test, said button cell being identical to that mentioned above, except that the assembly does not comprise a polymeric layer.

This assembly not according to the invention has been formed from an electrode coated with an ink identical to that used for the example of the invention without resorting to the polymeric layer.

After drying, this electrode is punched to a diameter of 14 mm and compressed under a load of 2 tonnes. With this electrode in the form of pellet is associated a Selgard separator pellet and a Viledon separator pellet. This sandwich thereby formed is mounted in a button cell with three pressure shims and the assembly is arranged in an anhydrous glove box for the filling of electrolyte and crimping. The positive electrode is formed of lithium metal. There is no polymeric layer interposed between the electrode and the current collector.

The results of these cycling tests are reported in FIG. 2, which is a graph illustrating the evolution of the capacity C (in mA.h/g) as a function of the number of cycles N, curve a corresponding to the test carried out with the assembly according to the invention and curve b corresponding to the test carried out with the assembly not according to the invention.

For the test carried out with the assembly not according to the invention, the capacity drops very rapidly, when the number of cycles increases, which is not the case of the test carried out with the assembly according to the invention.

1. Assembly comprising a current collector and an electrode comprising silicon in its elementary form, wherein said current collector and said electrode are connected together via at least one of the surfaces thereof by an elastic polymer layer.

2. Assembly according to claim 1, wherein the elastic polymer layer comprises one or more polymers selected from the group consisting of thermoplastic polymers, thermosetting polymers, elastomers and mixtures thereof.

3. Assembly according to claim 2, wherein the thermoplastic polymers are selected from the group consisting of polyolefins and polystyrenes.

4. Assembly according to claim 2, wherein the elastomeric polymers are selected from the group consisting of natural rubbers, synthetic rubbers, styrene-butadiene copolymers, ethylene-propylene copolymers and silicones.

5. Assembly according to claim 1, wherein the current collector is in the form of an electricity conducting substrate.

6. Assembly according to claim 5, wherein the metal substrate is made of an element selected from the group consisting of copper, aluminium, nickel and mixtures thereof.

7. Assembly according to claim 5, wherein the electricity conducting substrate is coated on one of the surfaces thereof with a bundle of carbon nanotubes, said bundle passing through the elastic polymer layer so as to be in contact with the electrode.

8. Assembly according to claim 1, wherein the electrode comprises a carbon material.

9. Assembly according to claim 8, wherein the carbon material is selected from the group consisting of carbon black; activated carbon; carbon nanotubes, whether they are single, double or multi-walled; carbon fibres; graphene; fullerene; and mixtures thereof.

10. Assembly according to claim 8, wherein the silicon and the carbon material organise themselves in the form of a “core-shell” type structure, the core being constituted of carbon material and the shell being constituted of silicon, or vice versa.

11. Assembly according to claim 10, wherein the electrode comprises “core-shell” type structures, wherein:
the core is constituted of carbon nanotubes and the shell is constituted of silicon; or
the core is constituted of silicon and the shell is constituted of graphene or fullerene.

12. Assembly according to claim 1, comprising:
as current collector, an aluminium substrate coated on one of the surfaces thereof with a bundle of carbon nanotubes;
as electrode, an electrode made of composite material comprising silicon and a carbon material,
the bundle of carbon nanotubes passing through the polymeric layer so as to be in contact with said electrode.

13. Assembly according to claim 1, wherein the electrode is a negative electrode of a lithium battery.

14. Lithium battery comprising at least one electrochemical cell comprising:
an assembly as defined in claim 1, wherein the electrode constitutes the negative electrode of the battery;
a positive electrode; and
a separator arranged between said assembly via the electrode layer and said positive electrode, which separator comprises a lithium ion conducting electrolyte.
